(19) United States
(12) Patent Application Publication
(10) Pub. No.: US 2014/0036536 A1
(43) Pub. Date: Feb. 6, 2014

(54) MEMS SHUTTER CONTROL FOR A DISPLAY UTILIZING QUANTUM DOTS

(71) Applicant: APPLE INC., Cupertino, CA (US)

(72) Inventors: Shawn R. GETTEMY, San Jose, CA (US); Jean-Pierre S. Guillou, San Francisco, CA (US); David A. Doyle, San Francisco, CA (US)

(73) Assignee: Apple Inc., Cupertino, CA (US)

(21) Appl. No.: 13/665,701

(22) Filed: Oct. 31, 2012

Related U.S. Application Data
(60) Provisional application No. 61/677,858, filed on Jul. 31, 2012.

(51) Int. Cl. G09F 13/04; H01J 9/00; F21V 8/00

(52) U.S. Cl. 362/612; 362/613; 362/97.1; 445/24

(57) ABSTRACT

A display that utilizes a microelectromechanical (MEMS) shutter module in order to accommodate a quantum dot sheet outside of the display backlight is provided. The MEMS shutter module can be placed either above or below the quantum dot sheet in order to more efficiently control the color at each individual pixel, when the color is being rendered from the isotropic emissions of the quantum dot sheet.

### FIELD OF THE DISCLOSURE

This relates generally to the implementation of quantum dots in a display, and more particularly to an implementation in which the brightness of color is controlled by microelectromechanical systems (MEMS) shutters in order to allow a quantum dots layer to be placed outside of the backlight, closer to the viewing area of the display.

### BACKGROUND OF THE DISCLOSURE

Display screens of various types of technologies, such as liquid crystal displays (LCDs), organic light emitting diode (OLED) displays, etc., can be used as screens or displays for a wide variety of electronic devices, including such consumer electronics as televisions, computers, and handheld devices (e.g., mobile telephones, tablet computers, audio and video players, gaming systems, and so forth). LCD devices, for example, typically provide a flat display in a relatively thin package that is suitable for use in a variety of electronic goods. In addition, LCD devices typically use less power than comparable display technologies, making them suitable for use in battery-powered devices or in other contexts where it is desirable to minimize power usage.

Liquid crystal displays generally are made up of a backlight that provides visible light to a liquid crystal layer, which takes the light from the backlight and controls the brightness and color at each individual pixel in the display in order to render a desired image.

The backlight often contains light emitting diodes that are coated with a phosphor such as Yttrium Aluminum Garnet (YAG) in order to produce a white light, which the liquid crystal layer then uses to render desired colors for the display. One metric that can be used to judge the quality of a display is the color gamut produced by the backlight. Color gamut refers to the subset of colors that a display is able to produce and is a function of the spectral width of the red, blue and green being produced by the display. The smaller the spectral width, the better the color gamut produced by the display. One way to improve the color gamut of a display is to replace the YAG phosphor with quantum dots. Due to the fact that quantum dots release light isotropically, placing quantum dots in the backlight structure can add complexity to the backlight architecture. Placing the quantum dots in the liquid crystal layer, however, can be problematic, due to the fact that the liquid crystal display layer requires the light to be polarized in order to control the brightness of color, and quantum dots produce isotropic un-polarized light. The liquid crystal layer can be replaced by a MEMS shutter control layer, which does not require polarized light to control the brightness of color. By replacing the liquid crystal layer with a MEMS shutter control layer, quantum dots can be placed outside of the backlight architecture. This can allow the backlight to maintain a simpler architecture, while at the same time utilizing quantum dots to produce a display with a superior color gamut.

### SUMMARY OF THE DISCLOSURE

This relates to displays that utilize a microelectromechanical systems (MEMS) shutter module to control the color outputted at each pixel of the display when the color of light is generated at least in part by a quantum dot sheet that is located external to the backlight of the display.

A MEMS shutter module, which does not require polarized light to control color, can be used to accommodate a quantum dot sheet that is located outside of the backlight and emits isotropic light. The MEMS shutter module can allow the display to enjoy the superior color gamut provided by quantum dots, without adding substantial complexity to the backlight architecture of the display.

### BRIEF DESCRIPTION OF THE DRAWINGS

FIG. 1A illustrates an example mobile telephone that includes a display screen according to some disclosed examples.

FIG. 1B illustrates an example digital media player that includes a display screen according to some disclosed examples.

FIG. 1C illustrates an example personal computer that includes a display screen according to some disclosed examples.

FIG. 1D illustrates an example tablet computing device that includes a display screen according to some disclosed examples.

FIG. 2A illustrates an exemplary display screen stack-up according to some disclosed examples.

FIG. 2B illustrates exemplary layers of an LCD display screen stack-up according to some disclosed examples.

FIG. 3 illustrates an exemplary backlight according to some disclosed examples.

FIG. 4 illustrates an exemplary quantum dot sheet according to some disclosed examples.

FIG. 5 illustrates an exemplary backlight configured with a quantum dot sheet according to some disclosed examples.

FIG. 6 illustrates another exemplary backlight configured with a quantum dot sheet according to some disclosed examples.

FIGS. 7A and 7B illustrate an exemplary MEMS shutter according to some disclosed examples.

FIG. 8 illustrates an exemplary display stack-up with a MEMS shutter and quantum dots sheet according to some disclosed examples.

FIG. 9 illustrates a close up exploded view of a display stack up with a MEMS shutter and quantum dots sheet according to some disclosed examples.

FIG. 10 is a block diagram of an example computing system that illustrates one implementation of an example display with the MEMS shutter display utilizing quantum dots integrated with a touch screen according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

This relates to a display that employs a micoelectromechanical system (MEMS) shutter to control the brightness of colors emanating from a display, thereby allowing quantum dots to be implemented without adding substantial complexity to the backlight architecture. By taking advantage of the fact that MEMS shutter control displays do not require polarized light to control brightness, quantum dots which produce isotropic light can be placed outside of the backlight, thereby allowing the backlight to maintain a simpler architecture while at the same time taking advantage of the improved color gamut offered by quantum dots.

Although examples disclosed herein may be described and illustrated herein in terms of displays that utilize side emitting light emitting diodes (LED), it should be understood that the examples are not so limited, but are additionally applicable to top emitting LEDs or bottom emitting LEDs, laser diodes and other light sources. Furthermore, although examples may described in terms of displays, it should be understood that the examples are not so limited, but are additionally applicable to displays that are integrated with touch screens which can accept touch inputs from a user or object such as a stylus.

Display screens of various types of technologies, such as liquid crystal displays (LCDs), organic light emitting diode (OLED) displays, etc., can be used as screens or displays for a wide variety of electronic devices, including such consumer electronics as televisions, computers, and handheld devices (e.g., mobile telephones, tablet computers, audio and video players, gaming systems, and so forth). LCD devices, for example, typically provide a flat display in a relatively thin package that is suitable for use in a variety of electronic goods. In addition, LCD devices typically use less power than comparable display technologies, making them suitable for use in battery-powered devices or in other contexts where it is desirable to minimize power usage.

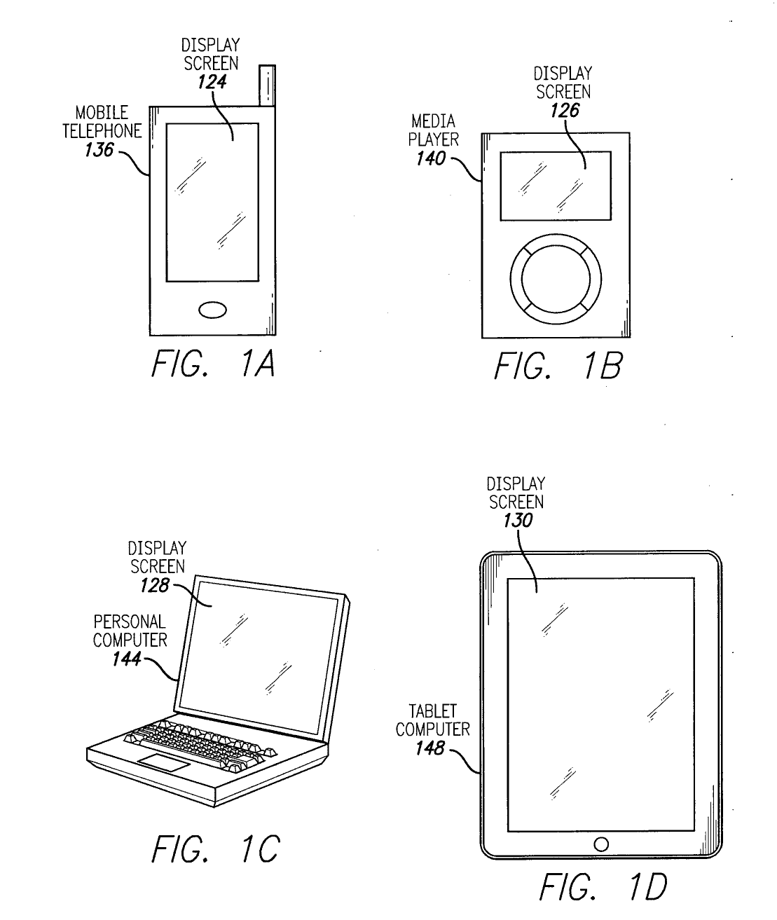

FIGS. 1A-1D show example systems in which display screens (which can be part of touch screens) according to examples of the disclosure may be implemented. FIG. 1A illustrates an example mobile telephone 136 that includes a display screen 124. FIG. 1B illustrates an example digital media player 140 that includes a display screen 126. FIG. 1C illustrates an example personal computer 144 that includes a display screen 128. FIG. 1D illustrates an example tablet computing device 148 that includes a display screen 130. Display screens 124, 126, 128 and 130 can include numerous layers that are stacked on top of each other and bonded together to form the display.

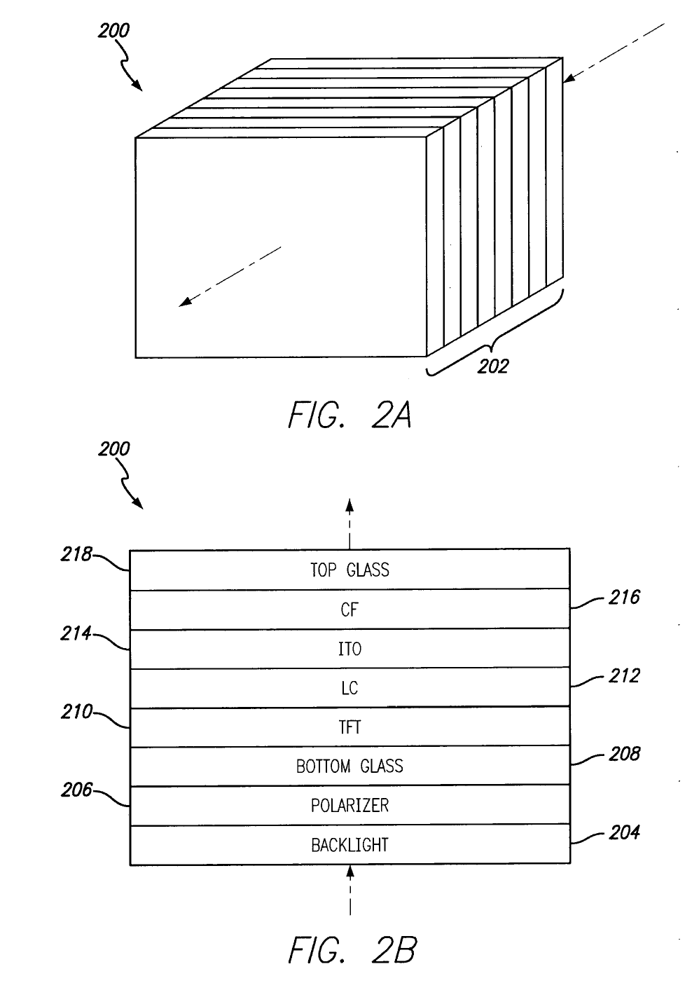

FIG. 2A illustrates an exemplary display screen stack-up according to some disclosed examples. Display screen 200 can contain a series of layers 202 that can be bonded or otherwise attached together to constitute the display. FIG. 2B illustrates exemplary layers of an LCD display screen stack-up according to some disclosed examples. Backlight 204 can provide white light that can be directed towards the aperture of the stack-up. As will be discussed below, the backlight can supply the rest of the display stack-up with light that can be oriented in particular orientation based on the needs of the rest of the stack-up. In order to control the brightness of the light, the white light produced by the backlight 204 can be fed into a polarizer 206 that can impart polarity to the light. The polarized light coming out of polarizer 206 can be fed through bottom cover 208 into a liquid crystal layer 212 that can be sandwiched between an Indium Tin Oxide (ITO) layer 215 and a Thin Film Transistor (TFT) layer 210. TFT substrate layer 210 can contain the electrical components necessary to create the electric field, in conjunction with ITO layer 214, that drives the liquid crystal layer 212. More specifically, TFT substrate 210 can include various different layers that can include display elements such as data lines, gate lines, TFTs, common and pixel electrodes, etc. These components can help create a controlled electric field that orients liquid crystals located in liquid crystal layer 212 into a particular orientation, based on the desired color to be displayed at any particular pixel. The orientation of a liquid crystal element in liquid crystal layer 212 can alter the orientation of the polarized light that is passed through it from backlight 204. The altered light from liquid crystal layer 212 can then be passed through color filter layer 216. Color filter layer 216 can contain a polarizer. The polarizer in color filter layer 216 can interact with the polarized light coming from liquid crystal layer 212, whose orientation can be altered depending on the electric field applied across the liquid crystal layer. The amount of light allowed to pass through color filter layer 216 into top cover 218 can be determined by the orientation of the light as determined by the orientation of the liquid crystal layer 212. While the top cover 218 is described as being glass any type of transparent cover can be used including plastic for example. By polarizing the white light coming out of backlight 204, changing the orientation of the light in liquid crystal layer 212, and then passing the light through a polarizer in color filter layer 216, the brightness of light can be controlled on a per pixel basis. Color filter layer 216 also can contain a plurality of color filters that can change the light passed through it into red, green and blue. By controlling the brightness and color of light on a per pixel basis, a desired image can be rendered on the display.

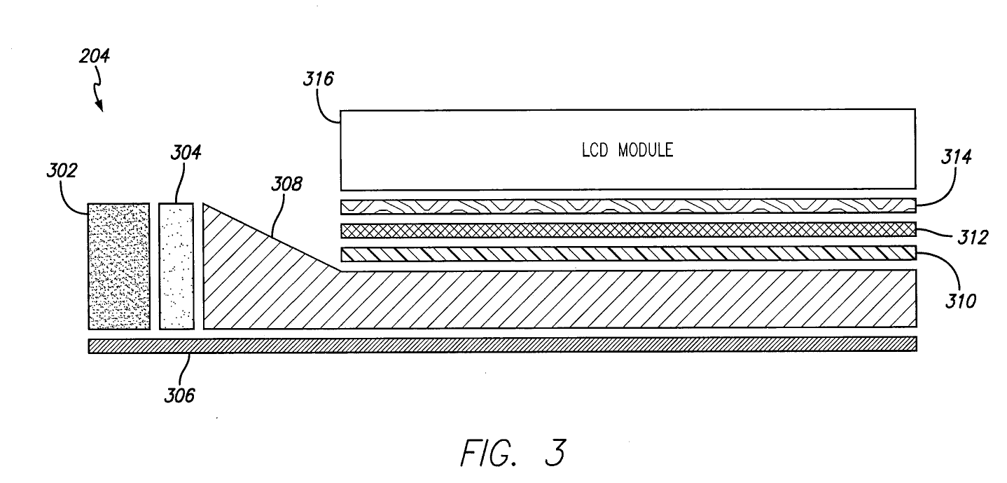

FIG. 3 illustrates an exemplary backlight according to some disclosed examples. Backlight 204 can be made up of a plurality of elements that can be arranged so as to provide white light to the rest of display stack-up 200. Backlight 204 can contain light emitting diode (LED) 302, which can act as the primary light source for the entire display stack-up 200. As pictured, LED 302 can be a side emitting LED. The light generated by LED 302 can irradiate a phosphor 304 that can produce a light of a particular color or colors when excited by light source such as an LED. As an example, the phosphor 304 can contain a Yttrium Aluminum Garnet (YAG) coating in order to produce red, blue and green light. The light emitted from the phosphor 304 can then be fed into light guide 308, which in conjunction with reflective plate 306 can work to turn the light being emitted from the side emitting LED 302 into the LCD module. The light that is emitted upwards toward the LCD module 316 can first enter prism sheet 310, which can act to turn the light further, so that it can enter the LCD module perpendicular to its bottom plane. The light that passes through prism sheet 310 can also be fed into a diffuser 312. Diffuser 312 can act to mix the red, green and blue light emitted from phosphor 304 in order to create white light. The mixed light from diffuser 312 can then be fed into a second prism sheet 314 that can again turn the direction of the light, so that it can enter the LCD module 316 perpendicularly.

In one example of a backlight implementation, the LED 302 can produce a white light that can be used to illuminate a YAG phosphor layer 304 that can be configured to output red, blue and green wavelengths of light when excited by the LED. While a YAG phosphor 304 can be configured to output red, green and blue light, the exact wavelength of red, blue and green light emitted cannot be precisely tuned, and the YAG phosphor can emit light of each color over a varying range of frequencies. In the color filter 216, in order to let the light pass through as much as possible to maximize the efficiency of the LCD module, a spectrally broad color filter can be used. While the broad color filter helps to maximize efficiency, this can also lead to a diminished color quality and color gamut of the display. For example, a diminished color quality and gamut can lead to images in which green colors are not pure green, but instead have tints of yellow, and red colors can have tints of orange.

To overcome some of the disadvantages that a backlight with a YAG phosphor can introduce, the YAG phosphor can be replaced by quantum dots. Quantum dots (QDs) are tiny, nanocrystal phosphors that are about 2-10 nm in size. They are distinguishable from bulk semiconductor material (used to fabricate LEDs) not only in size, but also by their energy levels. The energy levels in bulk material can be so close together that the levels are essentially continuous; however, quantum dots can contain only two discrete energy bands that can be occupied by the electrons. The valence band is located below the bandgap and the conduction band is located above the bandgap. When an electron in the valence band is imparted with sufficient energy to surmount the bandgap, it can become excited and jump to the conduction band. The electron will then want to return to its lowest energy state, and in doing so, will release energy in the form of electromagnetic radiation. The electron will fall back down to the valence band, emitting a photon with wavelength corresponding to the wavelength of radiation or the bandgap energy. For quantum dots, their small size leads to quantum confinement, where the energy levels then become discrete and quantized with finite separation. When the quantum dots are excited, the electromagnetic radiation corresponding to the wavelength can be released in the form of light. The main difference relative to bulk material is that the discrete energy levels for the QDs can allow for precise tunability of the emitted photon. For quantum dots, the energy levels can be finely tuned based on the size of the dot, which in turn leads to tuning the wavelength of the emitted photon. This tunability can allow the QDs the ability to emit nearly any frequency of light, a quality that bulk semiconductor material, and hence a stand-alone, standard light-emitting diode (LED) lacks. The quantum dots can be tuned to emit colors at more precise wavelengths relative to YAG phosphors with narrower spectral emission and a smaller full width at half maximum (FWHM) bandwidth. The heightened spectral precision of quantum dots can allow the color filter in color filter layer 216 to be narrowed, thus improving both the color quality and color gamut of the display. Quantum dots can be formed on a sheet that is placed within the display, so that it can be exposed to the light produced by the LED 302.

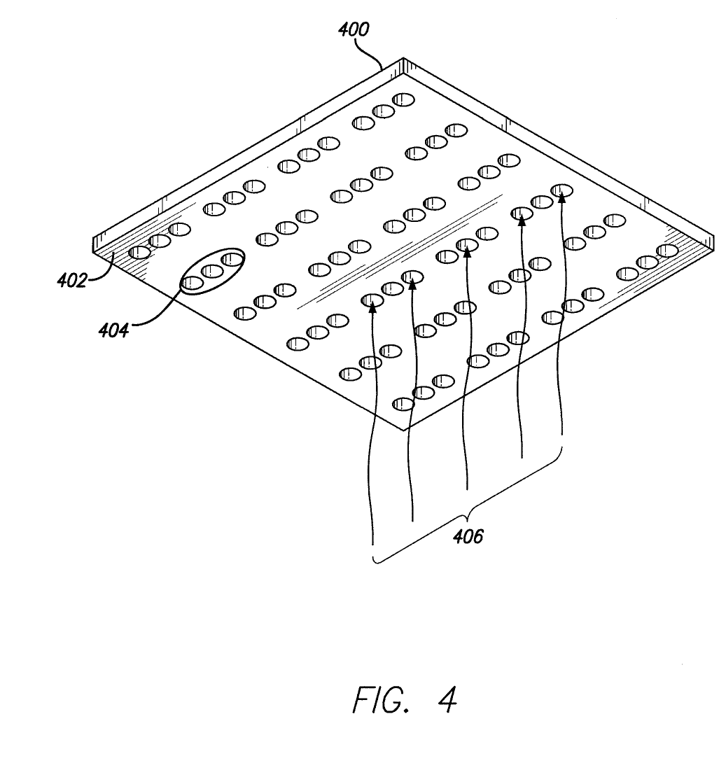

FIG. 4 illustrates an exemplary quantum dots sheet according to disclosed examples. Quantum dots sheet 400 can contain individual quantum dots 402. The quantum dots 402 can be arranged in groups 404, such that each group can contain, for example, 3 quantum dots, one red, one green and one blue, such that the light generated by each group when mixed together can produce white light. In other examples, a blue LED can be used to excite the quantum dots, obviating the need for quantum dots that emit blue light, and thus group 404 may contain only red and green quantum dots. Thus the red and green light emitted from the quantum dots can be mixed with the light from a blue LED that is passed through the quantum dots sheet to form white light. Quantum dots sheet 400 can be excited by a light source 406. Light source 406 can be light emitted from an LED. In some examples, light source 406 can be ultra violet (UV) light. Light source 406 can provide the energy required to excite the quantum dots so that they emit photons of light at precisely tuned wavelengths. The wavelengths can be tuned by adjusting the size of the quantum dots. When light source 405 excites quantum dots 402, each quantum dot can release light. An excited quantum dot will release isotropic light. In other words, the light emitted from a quantum dot will be emitted uniformly in all directions from the quantum dot. This feature of quantum dots can play a significant role in determining where in the display architecture to integrate the quantum dots sheet 400.

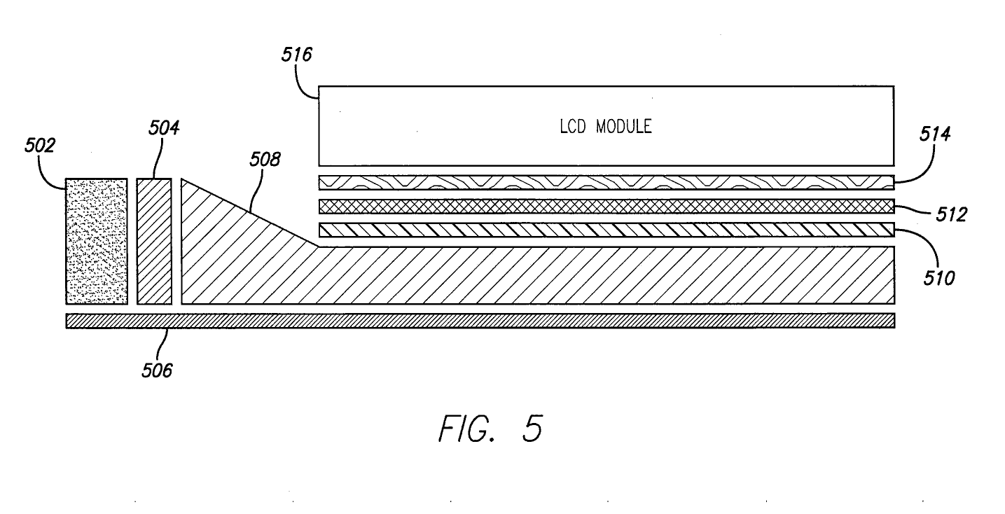

FIG. 5 illustrates an exemplary backlight configured with a quantum dot sheet according to one example. The backlight architecture illustrated in FIG. 5 is similar to the backlight architecture illustrated in FIG. 3 and discussed above. One difference is that the phosphor 304 of FIG. 3 is replaced by quantum dot sheet 502. In this example, LED 502 emits a light that can excite quantum dot sheet 504. When LED 502 illuminates quantum dot sheet 504, the quantum dot sheet can begin to emit isotropic light. The light emitted from quantum dot sheet 504 can then be fed into light guide 508, which, in conjunction with reflective plate 506, can work to guide the light being emitted from the quantum dot sheet 504 up into the LCD module. The light that is emitted upwards toward the LCD module 516 can first enter prism sheet 510, which can act to turn the light further, so that it can enter the LCD module perpendicular to its bottom plane. The light that passes through prism sheet 510 can also be fed into a diffuser 512. Diffuser 512 can act to mix the red, green and blue light emitted from phosphor 504 in order to create white light. The mixed light from diffuser 512 can then be fed into a second prism sheet 514 that can again turn the direction of the light so that it can enter the LCD module 516 perpendicularly.

The configuration described above can present difficulties. By placing the quantum dot sheet 504 next to LED 502, the quantum dot sheet may be susceptible to deformities caused by heat generated from the LED. For instance, a quantum dot in quantum dot sheet 504 may need to maintain a particular separation from any adjacent quantum dots in order to accurately guide each individual beam of colored light through the backlight. The separation between adjacent dots can be maintained by a chemical that agglutinates to each dot, and can prevent each dot from colliding with another. Heat from LED 502 can cause the agglutination to degrade and can cause quantum dots in quantum dot sheet 504 to move. Any shift in position of the quantum dots can cause the pattern of light emitted from quantum dot sheet 504 to lose uniformity and precision, and this can cause defects in the images displayed by the display.

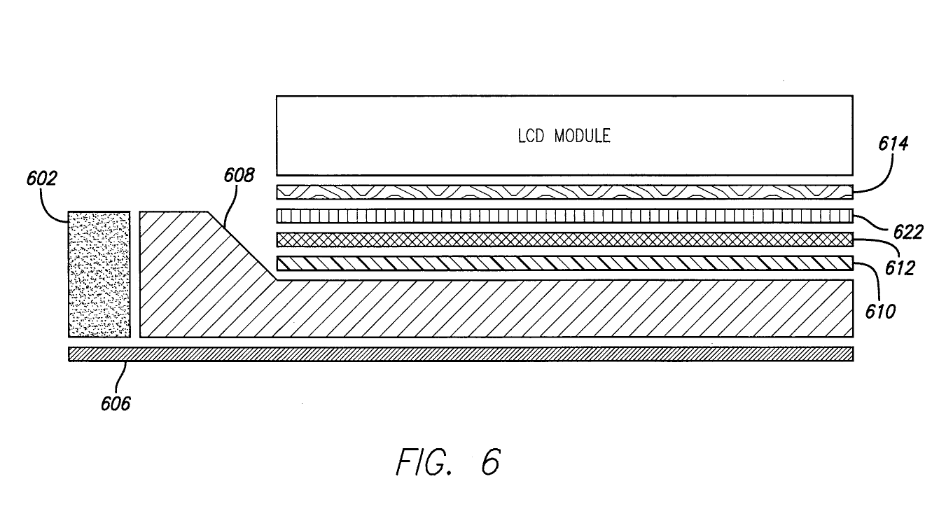

FIG. 6 illustrates another exemplary backlight configured with a quantum dot sheet according to one example. In this example, the quantum dot sheet is moved away from LED 602, and is placed between diffuser 612 and prism sheet 614. While the quantum dot sheet 622 is illustrated in FIG. 6 as being placed between diffuser sheet 612 and prism sheet 614, in other examples prism sheet 610, diffuser sheet 612, quantum dot sheet 622 and prism sheet 614 can be arranged in other combinations or orders. Placing the quantum dot sheet 622 proximal to the diffuser and prism sheets can be advantageous in that the quantum dot sheet 622 is positioned further away from LED 622 and thus can be less susceptible to the effects of heat generated by the LED. However, integrating the quantum dot sheet 612 amongst the prism sheet 610, diffuser 612 and second prism sheet 614 can present disadvantages. As discussed above, the light emitted from an excited quantum dot is isotropic. Because the light is isotropic, in order to impart the directionality to the light necessary to ensure that the light enters the display module at the proper orientation, additional prism and diffuser sheets may be necessary. Additional prism sheets and diffusers can add both complexity and size to the display, and can make the overall display thicker.

Because placing the quantum dot sheet next to the LED can cause thermal concerns, and placing the quantum dot sheet in other areas of the backlight can add both complexity and size to the backlight, in some examples the quantum dot sheet can be placed outside of the backlight and within the display module. However, placing the quantum dots sheets in a display module that utilizes liquid crystals to control the brightness and color produced by a display can be problematic. As shown in FIG. 2B and discussed above, the light emanating from the backlight 204 can be fed into polarizer 206. As discussed above in reference to FIG. 3, the light emanating from the backlight can be guided by the combination of the light guide, prism sheets, and diffuser sheet so that it can enter the polarizer 206 in a particular orientation. Polarizer 206 can allow light in one particular orientation to pass through. The light can then enter the liquid crystal layer 212, where its orientation can be changed based on the orientation of the liquid crystal element. A liquid crystal element in liquid crystal layer 212 can have its orientation changed by applying an electric field across it. The light leaving liquid crystal layer 212 can then be fed into color filter layer 216. Color filter layer 216 can contain another polarizer. Liquid crystal layer 212 can change the orientation of light, such that when it hits the polarizer in color filter layer 216, little or no light is able to pass through. Liquid crystal layer 212 can also change the orientation of light such that when it hits the polarizer in color filter 216, most or all of the light is able to pass through. Liquid crystal layer 212 can also change the orientation of light, such that when it hits the polarizer5 in color filter 216, a partial amount of light is able to pass through.

Introducing a quantum dot sheet into a display module that utilizes a method of controlling brightness and color outputted by the display as described above can be problematic. As discussed with reference to FIG. 4, when a quantum dot is excited it emits isotropic light. When the quantum dot sheet resides in the backlight, as discussed above, the backlight architecture may have to be modified in order to ensure that the isotropic light is directed up into the aperture of the display module, so that the light can be viewed properly by a user of the display. Because the light emitted by a quantum dot is isotropic, if the quantum dot sheet is introduced into the display module, the directionality of the light provided by backlight architecture can be lost. Referring to FIG. 2B, placing the quantum dot sheet between backlight 204 and polarizer 206 could reduce the efficiency of the display, since much of the light emitted by the quantum dot sheet would be rejected by the polarizer. Placing a quantum dot sheet anywhere after the polarizer 206 could cause the liquid crystal display mechanism, by which the brightness of the light emanating from each pixel is controlled, to break down since the polarizer in color filter 216 would always have light passing through it regardless of the orientation of the liquid crystal. Thus, in order to utilize a quantum dot sheet without requiring significant modification to the backlight, it may be necessary to replace the LCD module, which uses liquid crystals to control the flow of light, with an alternative method of controlling the light emanating from a display.

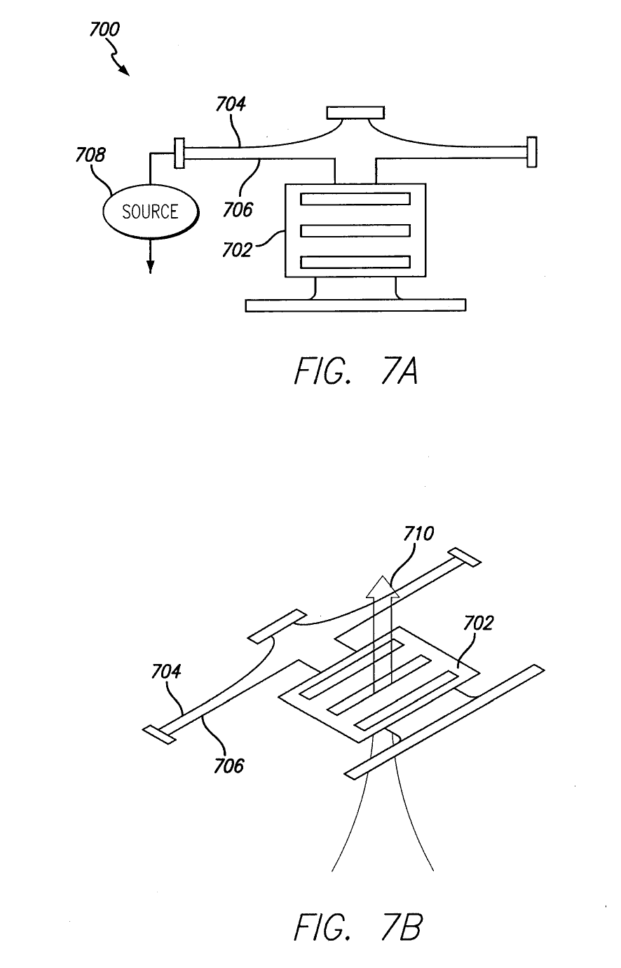

FIG. 7A illustrates an exemplary MEMS shutter according to one disclosed example. MEMS shutter 700, in some examples, can contain a shutter 702 which can be used to either allow light to pass through or block light depending on its orientation relative to the light. The orientation of shutter 702 can be controlled by a conductive line 706 that is attached to the shutter. Source 708 can provide a current to conductive line 706 that can cause the conductive line to become electrically attracted to line 704. Line 704 is held in a fixed position, and thus the attractive force that is created between conductive line 706 and line 704, causes conductive line 706 to pull closer to line 704. This pulling motion can cause the optical shutter 702 attached to line 706 to move along with it, thus altering the position of the optical shutter. The position of the optical shutter 702 can determine whether light is able to pass through the shutter, or if light is blocked by the shutter.

FIG. 7B illustrates an exemplary interaction between a MEMS shutter and light. When conductive line 706 is stimulated, it can be drawn to line 704, thus pulling shutter 702 along with it. This movement changes the position of shutter 702. As shown, light 710 is allowed to pass through the optical shutter 702 when conductive line 706 is not stimulated; however, when the shutter changes position, light 710 may no longer be able to pass through. The brightness of light emanating from a pixel that uses a MEMS optical shutter can be controlled by altering the duty cycle of when the shutter is passing light vs. when the shutter is blocking light. To achieve maximum brightness, the shutter can be positioned so that it allows light to pass through during the full duration of an image frame. If the desire is to have no light pass through during a frame, the shutter can be positioned so that it allows little or no light to pass through during the full duration of an image frame. If a median amount of brightness is desired, then the optical shutter can be positioned so that it allows light to pass through for half of a frame, and the shutter can be positioned so that it allows little or no light to pass through for the other half of the frame. As more brightness is desired, the amount of time that the shutter is in a position to allow light to pass through can be increased. As less brightness is desired, the amount of time that the shutter is in a position to block light can be increased. The stimulation source 708 can be pulse width modulated to control the duty cycle of light being passed through the optical shutter 702.

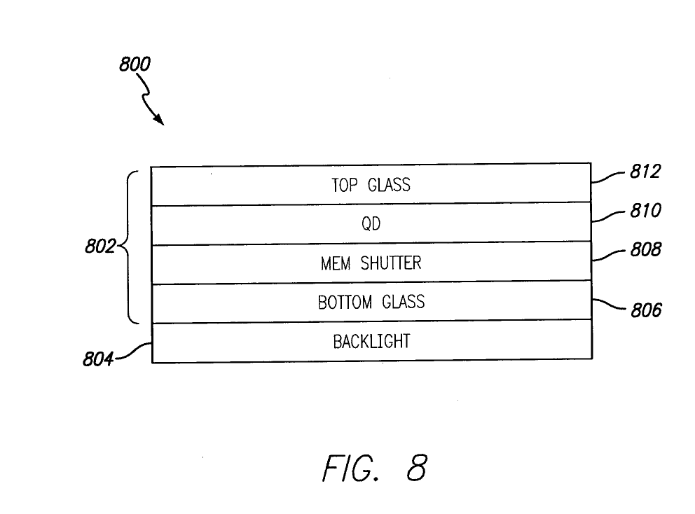

FIG. 8 illustrates an exemplary display stack-up with a MEMS shutter and quantum dot sheet according to one disclosed example. In this example, the LCD display module discussed above can be replaced by a MEMS shutter module 802. Display stack-up 800 can contain a backlight 804 and a MEMS shutter module 802. MEMS shutter module 802 can contain a bottom glass 806, a MEMS shutter layer 808, a quantum dot sheet 810 and a top glass 812. Backlight 804 can provide directed light to MEMS display module 802. The light can pass through bottom glass 806 and into MEMS shutter layer 808. MEMS shutter layer 808 can control the intensity of light at each individual pixel using the functionality described above in reference to FIGS. 7A and 7B. The light passed by the MEMS shutter layer 808 can then be used to excite individual quantum dots in the quantum dot sheet 810. The light emitted by the quantum dot sheet 810 can then pass through top glass 812, where it can then be viewed by the user of the display. In other examples, the quantum dot sheet 810 can be placed under the MEMS shutter layer 808.

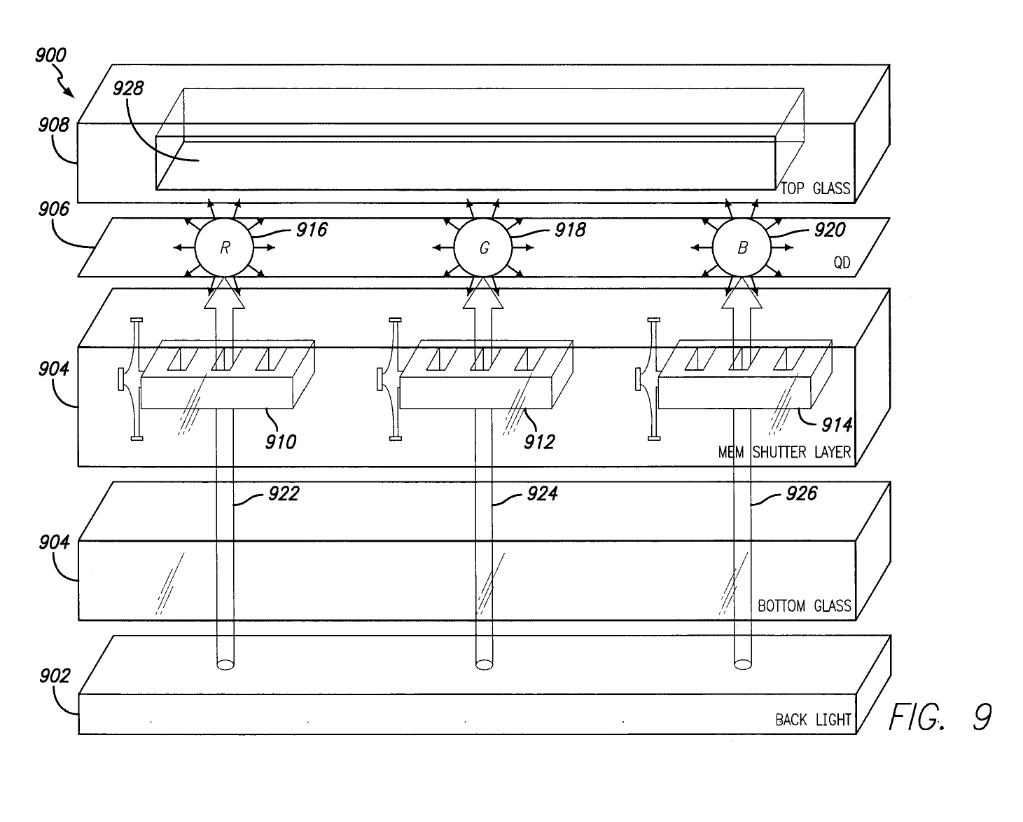

FIG. 9 illustrates a single pixel exploded view of a display stack up with a MEMS shutter and quantum dot sheet according to one disclosed example. As shown in FIG. 9, backlight 902 can produce a plurality of light beams used by the display stack-up 900 to render a desired image. As illustrated, in this example, three beams of light can be seen emanating from the backlight. Light beam 922 can eventually be used to excite red quantum dot 916. Light beam 924 can eventually be used to excite green quantum dot 918, and light beam 926 can eventually be used to excite blue quantum dot 920. The red, green and blue quantum dots are subpixels that make up pixel 928. A quantum dot could be excited by multiple beams. Furthermore, red, green, or blue light could be generated directly by an LED source, thus obviating the need for one or more of the colored quantum dots. Each light beam 922, 924 and 926 can pass through a MEMS shutter layer 904. MEMS shutter 904 can control the amount of light from each individual light beam that excites each individual quantum dot. Turning to the red quantum dot 916 as an example, when light beam 922 enters MEMS shutter layer 904, MEMS shutter 910 can control how much light from light beam 922 impinges on red quantum dot 916. By controlling the amount of light impinging on red quantum dot 916, one can control the amount of red light produced by the quantum dot. The amount of red light emanating from quantum dot 916 is a function of the amount of energy imparted on the quantum dot. The amount of energy imparted on the quantum dot is a function of the duty cycle of the MEMS shutter 910 in allowing light to pass v. blocking the light as described above in reference to FIGS. 7A and 7B. In order to render a desired color out of pixel 928, the amount of red light, green light and blue light emanating out of quantum dots 916, 918 and 920 respectively can be controlled by MEMS shutters 910, 912, and 914. For instance, to generate a pure purple color, MEMS shutter 910, associated with red quantum dot 916, and MEM shutter 914 associated with blue quantum dot 920 can allow equal amounts of light to excite the quantum dot, thus generating light that is equal parts red and blue. MEMS shutter 912 associated with green quantum dot 918 can block any light from impinging on the green quantum dot during the frame. The light can mix above the quantum dots, and because the mixed light consists of equal parts red and blue with no green, a pure purple color will appear at pixel 928. From the example above, any desired color can be rendered by controlling the proportions of red, blue and green light emanating from quantum dot sheet 906.

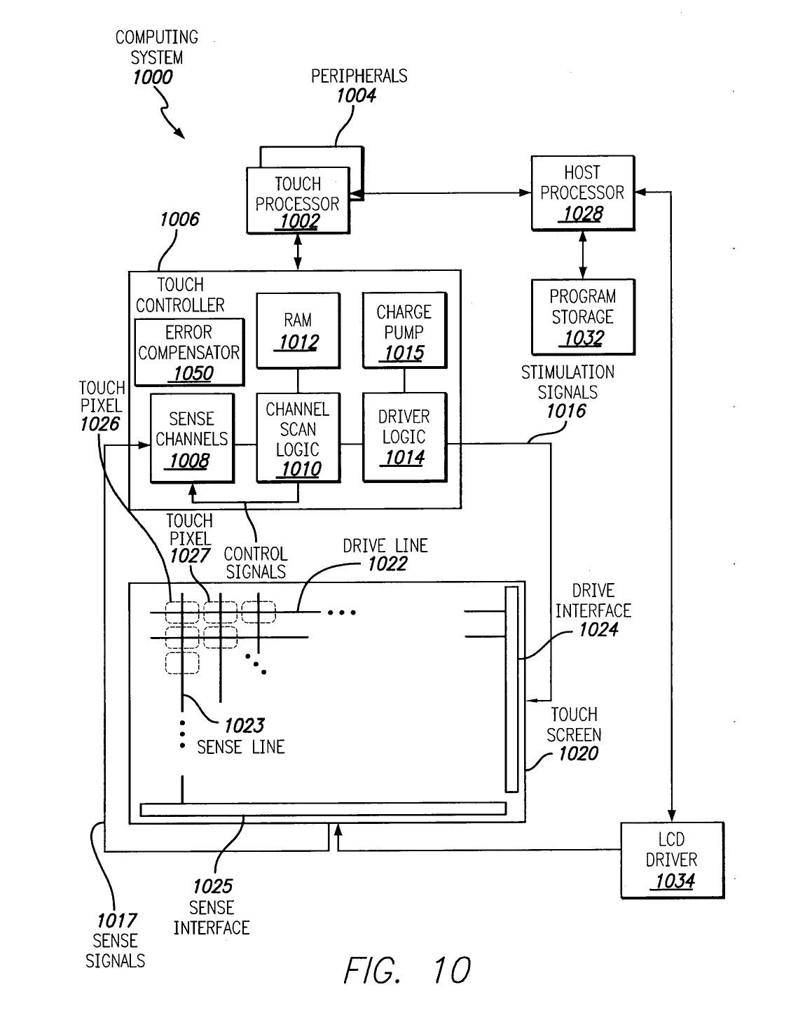

FIG. 10 is a block diagram of an example computing system 1000 that illustrates one implementation of an example display with the MEMS shutter display utilizing quantum dots described above integrated with a touch screen 1020 according to examples of the disclosure. Computing system 1000 could be included in, for example, mobile telephone 136, digital media player 140, personal computer 144, or any mobile or non-mobile computing device that includes a touch screen. Computing system 1000 can include a touch sensing system including one or more touch processors 1002, peripherals 1004, a touch controller 1006, and touch sensing circuitry. Peripherals 1004 can include, but are not limited to, random access memory (RAM) or other types of memory or storage, watchdog timers and the like. Touch controller 1006 can include, but is not limited to, one or more sense channels 1008, channel scan logic 1010 and driver logic 1014. Channel scan logic 1010 can access RAM 1012, autonomously read data from the sense channels and provide control for the sense channels. In addition, channel scan logic 1010 can control driver logic 1014 to generate stimulation signals 1016 at various frequencies and phases that can be selectively applied to drive regions of the touch sensing circuitry of touch screen 1020, as described in more detail below. In some examples, touch controller 1006, touch processor 102 and peripherals 1004 can be integrated into a single application specific integrated circuit (ASIC).

Computing system 1000 can also include a host processor 1028 for receiving outputs from touch processor 1002 and performing actions based on the outputs. For example, host processor 1028 can be connected to program storage 1032 and a display controller, such as an LCD driver 1034. Host processor 1028 can use LCD driver 1034 to generate an image on touch screen 1020, such as an image of a user interface (UI), and can use touch processor 1002 and touch controller 1006 to detect a touch on or near touch screen 1020, such a touch input to the displayed UI. The touch input can be used by computer programs stored in program storage 1032 to perform actions that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 1028 can also perform additional functions that may not be related to touch processing.

Integrated display and touch screen 1020 can include touch sensing circuitry that can include a capacitive sensing medium having a plurality of drive lines 1022 and a plurality of sense lines 1023. It should be noted that the term “lines” is sometimes used herein to mean simply conductive pathways, as one skilled in the art will readily understand, and is not limited to elements that are strictly linear, but includes pathways that change direction, and includes pathways of different size, shape, materials, etc. Drive lines 1022 can be driven by stimulation signals 1016 from driver logic 1014 through a drive interface 1024, and resulting sense signals 1017 generated in sense lines 1723 can be transmitted through a sense interface 1025 to sense channels 1008 (also referred to as an event detection and demodulation circuit) in touch controller 1006. In this way, drive lines and sense lines can be part of the touch sensing circuitry that can interact to form capacitive sensing nodes, which can be thought of as touch picture elements (touch pixels), such as touch pixels 1026 and 1027. This way of understanding can be particularly useful when touch screen 1020 is viewed as capturing an “image” of touch. In other words, after touch controller 1006 has determined whether a touch has been detected at each touch pixel in the touch screen, the pattern of touch pixels in the touch screen at which a touch occurred can be thought of as an “image” of touch (e.g. a pattern of fingers touching the touch screen).

In some examples, touch screen 1020 can be an integrated touch screen in which touch sensing circuit elements of the touch sensing system can be integrated into the display pixels stackups of a display.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

Accordingly, some examples of the disclosure relate to a display screen comprising: a backlight, and top cover disposed above the backlight, a micrelectromechanical shutter module disposed between the backlight and the top cover, and a quantum dot sheet disposed between the backlight and the top cover. In other examples the quantum dot sheet is disposed between the backlight and the microelectromechanical shutter module. In other examples, the quantum dot sheet is disposed between the microelectromechanical shutter module and the top cover. In other examples the backlight comprises: a plurality of light emitting diodes, one or more prism sheets, one or more diffuser sheets, and a light guide. In other examples the plurality of light emitting diodes are top emitting diodes. In other examples, the plurality of light emitting diodes are side emitting diodes. In other examples the quantum dot sheet comprises of one or more quantum dots, and the one or more quantum dots are configured to emit light in a plurality of colors. In other examples, the quantum dot sheet is further configured to allow a light beam from the backlight to pass through without interacting with a quantum dot. In other examples the quantum dot sheet is configured to emit light in a plurality of colors and the microelectromechanical shutter module is configured to control an intensity of each color of light of the plurality of colors emitted from the display. In other examples, the microelectromechanical shutter module consists of a plurality of microelectromechanical shutters, and the intensity of each color of light of the plurality of colors emitted from the display is controlled by applying a plurality of electrical signals to each microelectromechanical shutter of the plurality of microelectromechanical shutters.

Other examples of the disclosure relate to a method of forming a display, the method comprising: locating a top cover above a backlight, locating a microelectromechanical shutter module between the top cover and the backlight; and locating a quantum dot sheet between the backlight and the top cover. In other examples, the method further comprises locating the quantum dot sheet between the backlight and the microelectromechanical shutter module. In other examples, the method further comprises locating the quantum dot sheet between the microeelctromechanical shutter module and the top cover. In other examples, the backlight is formed by locating a plurality of light emitting diodes proximal to a light guide, locating one or more prism sheets above the light guide, and locating one or more diffuser sheets above the light guide. In other examples, the plurality of light emitting diodes are top emitting diodes. In other examples the plurality of light emitting diodes are side emitting diodes. In other examples the quantum dot sheet is formed by locating a plurality of quantum dots within the sheet, and the plurality of quantum dots are configured to emit light with a plurality of colors. In other examples the quantum dot sheet is formed to allow a light beam from the backlight to pass through the sheet without interacting with a quantum dot. In other examples the method further comprises configuring the quantum dot sheet to emit light of a plurality of colors and configuring the microelectromechanical shutter module to control an intensity of each color of light of the plurality of colors emitted from the display. In other examples the microelectromechanical shutter module is formed with a plurality of microelectromechanical shutters, and the instensity of each color of light of the plurality of colors emitted from the display is controlled by applying a plurality of electrical signals to each microelectromechanical shutter of the plurality of microelectromechanical shutters.

What is claimed is:

1. A display screen comprising:
a backlight;
a top cover disposed above the backlight;
a microelectromechanical shutter module disposed between the backlight and the top cover; and
a quantum dot sheet disposed between the backlight and the top cover.

2. The display screen of claim 1, wherein the quantum dot sheet is disposed between the backlight and the microelectromechanical shutter module.

3. The display screen of claim 1, wherein the quantum dot sheet is disposed between the microelectromechanical shutter module and the top cover.

4. The display screen of claim 1, wherein the backlight comprises:
a plurality of light emitting sources;
one or more prism sheets;
one or more diffuser sheets; and
a light guide.

5. The display screen of claim 1, wherein the backlight comprises:
a light guide configured to integrate the combined functions of one or more prism sheets and one or more diffuser sheets.

6. The display screen of claim 4, wherein the plurality of light emitting sources are light emitting diodes and wherein the light emitting diodes are top emitting diodes.

7. The display screen of claim 4, wherein the plurality of light emitting sources are light emitting diodes and wherein light emitting diodes are side emitting diodes.

8. The display screen of claim 4, wherein the plurality of light emitting sources are laser diodes.

9. The display screen of claim 1, wherein the quantum dot sheet comprises one or more quantum dots, and the one or more quantum dots are configured to emit light in a plurality of colors.

10. The display screen of claim 9, wherein the quantum dot sheet is further configured to allow a light beam from the backlight to pass through without interacting with a quantum dot.

11. The display of claim 1, wherein the quantum dot sheet is configured to emit light in a plurality of colors, and wherein the microelectromechanical shutter module is configured to control an intensity of each color of light of the plurality of colors emitted from the display.

12. The display of claim 11, wherein the microelectromechanical shutter module includes a plurality of microelectromechanical shutters, and wherein the intensity of each color of light of the plurality of colors emitted from the display is controlled by applying a plurality of electrical signals to each microelectromechanical shutter of the plurality of microelectromechanical shutters.

13. A method of forming a display, the method comprising:
locating a top cover above a backlight ;
locating a microelectromechanical shutter module between the top cover and the backlight; and
locating a quantum dot sheet between the backlight and the top cover.

14. The method of claim 13, further comprising locating the quantum dot sheet between the backlight and the microelectromechanical shutter module.

15. The method of claim 13, further comprising locating the quantum dot sheet between the microelectromechanical shutter module and the top cover.

16. The method of claim 13, wherein the backlight is formed by:
locating a plurality of light emitting sources proximal to a light guide;
locating one or more prism sheets above the light guide; and
locating one or more diffuser sheets above the light guide.

17. The method of claim 16, wherein the plurality of light emitting sources are light emitting diodes and wherein the light emitting diodes are top emitting diodes.

18. The method of claim 16, wherein the plurality of light emitting sources are light emitting diodes and wherein the light emitting diodes are side emitting diodes.

19. The method of claim 16, wherein the plurality of light emitting sources are laser diodes.

20. The method of claim 13, wherein the quantum dot sheet is formed by locating a plurality of quantum dots within the sheet, and wherein the plurality of quantum dots are configured to emit light with a plurality of colors.

21. The method of claim 20, wherein the quantum dot sheet is formed to allow a light beam from the backlight to pass through the sheet without interacting with a quantum dot.

22. The method of claim 13, further comprising configuring the quantum dot sheet to emit light of a plurality of colors and configuring the microelectromechanical shutter module to control an intensity of each color of light of the plurality of colors emitted from the display.

23. The method of claim 22, wherein the microelectromechanical shutter module is formed with a plurality of microelectromechanical shutters, and wherein the intensity of each color of light of the plurality of colors emitted from the display is controlled by applying a plurality of electrical signals to each microelectromechanical shutter of the plurality of microelectromechanical shutters.
